(19) United States
(12) Patent Application Publication
(10) Pub. No.: US 2026/0189924 A1
(43) Pub. Date: Jul. 2, 2026

(54) APPARATUS, SYSTEM, AND METHOD OF SERVER-BASED SETTING OF BLUETOOTH (BT) PARAMETERS

(71) Applicant: INTEL CORPORATION, Santa Clara, CA (US)

(72) Inventors: Srinivas Krovvidi, Hyderabad (IN); Anshu Agarwal, Yemlur (IN); Chandrashekar Devegowda, B.T.S Main Road (IN); Mythili Hegde, Bangalore (IN); Tarun Arora, Bengaluru (IN); Vinay Prasad B R, Bangalore (IN)

(73) Assignee: INTEL CORPORATION, Santa Clara, CA (US)

(21) Appl. No.: 19/002,624

(22) Filed: Dec. 26, 2024

(51) Int. Cl. H04W 16/14; H04W 24/02; H04W 84/10

(52) U.S. Cl. CPC H04W 16/14; H04W 24/02; H04W 84/10

(57) ABSTRACT

For example, an apparatus may include logic and circuitry configured to cause a wireless communication device to send communication information to a Bluetooth (BT) parameter-setting server. For example, the communication information may be based on wireless communications communicated by the wireless communication device. For example, the wireless communication device may be configured to process BT parameter-setting information from the BT parameter-setting server to identify a setting of one or more BT parameters to be implemented by a BT radio of the wireless communication device. For example, the wireless communication device may configure a setting of the BT radio, for example, according to the setting of the one or more BT parameters.

### BACKGROUND

A wireless communication device may include one or more radios, which may be configured for wireless communication according to one or more wireless communication technologies.

For example, a wireless communication device may include a Bluetooth (BT) radio, which may be configured to communicate with one or more BT devices, e.g., according to a suitable BT protocol.

For example, the wireless communication device may include one or more other radios, e.g., a Wireless Local Area network (WLAN) radio to communicate over a WLAN.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic flow-chart illustration of a method of Bluetooth parameter-setting, in accordance with some demonstrative aspects.

FIG. 3 is a schematic illustration of a Machine Learning (ML)-based Bluetooth parameter-setting mechanism, in accordance with some demonstrative aspects.

FIG. 4 is a schematic flow-chart illustration of a method of server-based setting of Bluetooth parameters, in accordance with some demonstrative aspects.

FIG. 5 is a schematic flow-chart illustration of a method of server-based setting of Bluetooth parameters, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [. . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing Bluetooth standards (“the Bluetooth standards”), e.g., including the Bluetooth Core Specification (Bluetooth Core Specification V 5.3, July 13, 2021), and/or future versions and/or derivatives thereof, devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020)) and/or future versions and/or derivatives thereof, devices and/or networks operating in accordance with existing cellular specifications and/or protocols, units and/or devices which are part of the above networks, and the like.

Some aspects may be used in conjunction with one way and/or two-way radio communication systems, a Bluetooth system, a Bluetooth Low Energy (BLE) system, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects are described herein with respect to Bluetooth (BT) communication, e.g., according to a BT protocol and/or a BLE protocol. However, other aspects may be implemented with respect to any other communication scheme, network, standard and/or protocol.

Some demonstrative aspects may be used in conjunction with a WLAN, e.g., a Wi-Fi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 GHz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

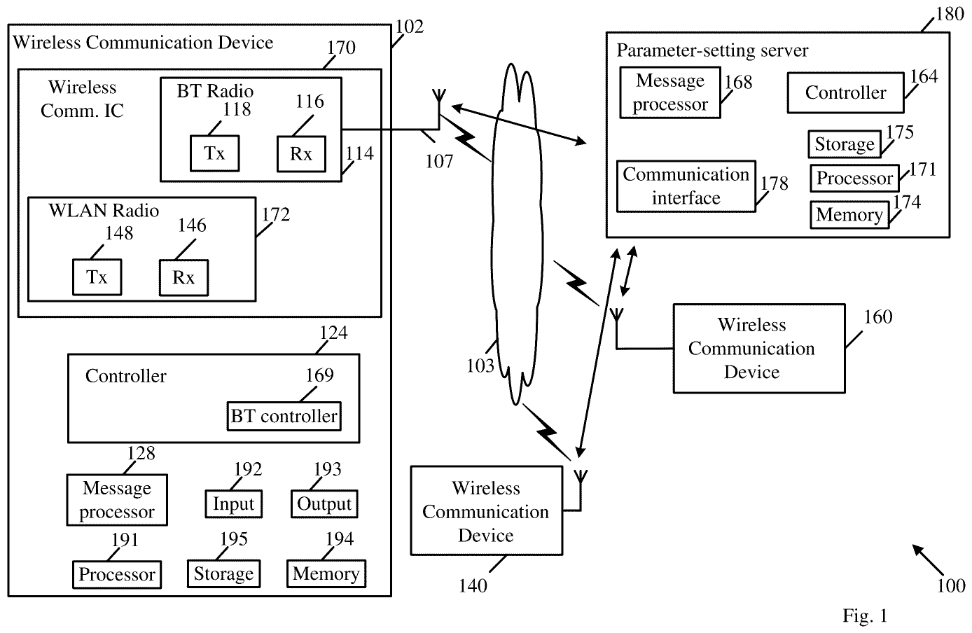

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, devices 102, 140, and/or 160 may include, operate as, and/or perform the functionality of one or more BT devices.

In some demonstrative aspects, device 102 may include a BT mobile device, device 140 may include a BT mobile device, and/or device 160 may include a BT mobile device. In other aspects, device 102, device 140, and/or device 160 may include a non-mobile BT device.

In one example, devices 102, 140, and/or 160 may include BT Low Energy (LE) (BLE) compatible devices. In other aspects, devices 102, 140, and/or 160 may include or implement any other additional or alternative BT communication functionality, e.g., according to any other additional or alternative BT protocol.

In some demonstrative aspects, devices 102, 140 and/or 160 may include, operate as, and/or perform the functionality of one or more STAs. For example, device 102 may include at least one station (STA), device 140 may include at least one STA, and/or devices 160 may include at least one STA.

In some demonstrative aspects, devices 102, 140 and/or 160 may include, operate as, and/or perform the functionality of one or more WLAN STAs.

In some demonstrative aspects, devices 102, 140 and/or 160 may include, operate as, and/or perform the functionality of one or more Wi-Fi STAs, e.g., Wi-Fi 8 STAs.

In one example, a STA may include a logical entity that is a singly addressable instance of a medium access control (MAC) and physical layer (PHY) interface to the wireless medium (WM). The STA may perform any other additional or alternative functionality.

In other aspects, devices 102, 140 and/or 160 may include, operate as, and/or perform the functionality of any other type of STA and/or device.

In some demonstrative aspects, device 102 may include, for example, one or more of a processor 191, an input unit 192, an output unit 193, a memory unit 194, and/or a storage unit 195. Device 102 may optionally include other suitable hardware components and/or software components. In some demonstrative aspects, some or all of the components of device 102 may be enclosed in a common housing or packaging, and may be interconnected or operably associated using one or more wired or wireless links. In other aspects, components of device 102 may be distributed among multiple or separate devices.

In some demonstrative aspects, processor 191 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications.

In some demonstrative aspects, input unit 192 may include, for example, a keyboard, a keypad, a mouse, a touch-screen, a touch-pad, a track-ball, a stylus, a microphone, or other suitable pointing device or input device. Output unit 193 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 may include, for example, a hard disk drive, a disk drive, a solid-state drive (SSD), and/or other suitable removable or non-removable storage units. Memory unit 194 and/or storage unit 195, for example, may store data processed by device 102.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a Wi-Fi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 GHz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices.

In some demonstrative aspects, devices 102, 140, and/or 160 may include one or more BT radios including circuitry and/or logic to perform wireless communication between devices 102, 140, 160, and/or one or more other BT devices.

In some demonstrative aspects, devices 102, 140, and/or 160 may include one or more other radios, e.g., a Wi-Fi radio, an OFDM radio, a cellular radio, and/or the like.

For example, device 102 may include one or more BT radios 114.

In some demonstrative aspects, BT radio 114 may include one or more wireless receivers (Rx) including circuitry and/or logic to receive wireless communication signals, RF signals, frames, blocks, transmission streams, packets, messages, data items, and/or data. For example, BT radio 114 may include at least one receiver 116.

In some demonstrative aspects, BT radio 114 may include one or more wireless transmitters (Tx) including circuitry and/or logic to transmit wireless communication signals, RF signals, frames, blocks, transmission streams, packets, messages, data items, and/or data. For example, BT radio 114 may include at least one transmitter 118.

In some demonstrative aspects, BT radio 114, transmitter 118, and/or receiver 116 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, BT radio 114 may include or may be implemented as part of a wireless Network Interface Card (NIC), and the like.

In some demonstrative aspects, BT radio 114 may be configured to communicate over a 2.4 GHz band, and/or any other band.

In some demonstrative aspects, BT radio 114 may include, or may be associated with one or more antennas.

In some demonstrative aspects, device 102 may include one or more antennas 107.

Antennas 107 may include any type of antennas suitable for transmitting and/or receiving wireless communication signals, blocks, frames, transmission streams, packets, messages and/or data. For example, antennas 107 may include any suitable configuration, structure and/or arrangement of one or more antenna elements, components, units, assemblies and/or arrays. In some aspects, antennas 107 may implement transmit and receive functionalities using separate transmit and receive antenna elements. In some aspects, antennas 107 may implement transmit and receive functionalities using common and/or integrated transmit/receive elements.

In some demonstrative aspects, BT radio 114 may be implemented as part of a wireless communication Integrated Chip (IC) 170, which may include at least one BT radio 114 and at least one other radio, e.g., a WLAN radio 172. For example, BT radio 114 and WLAN radio 172 may share the one or more antennas 107 and/or one or more other components, e.g., RF, PHY and/or MAC components, of wireless IC 170.

In other aspects, BT radio 114 and WLAN radio 172 may be implemented by separate elements and/or units, e.g., separate ICs, of wireless communication device 102.

In some demonstrative aspects, WLAN radio 172 may include one or more wireless receivers (Rx) including circuitry and/or logic to receive wireless communication signals, RF signals, frames, blocks, transmission streams, packets, messages, data items, and/or data. For example, WLAN radio 172 may include at least one receiver 146.

In some demonstrative aspects, WLAN radio 172 may include one or more wireless transmitters (Tx) including circuitry and/or logic to transmit wireless communication signals, RF signals, frames, blocks, transmission streams, packets, messages, data items, and/or data. For example, WLAN radio 172 may include at least one transmitter 148.

In some demonstrative aspects, WLAN radio 172 may be configured to communicate over a 2.4 GHz WLAN band.

In some demonstrative aspects, WLAN radio 172 may be configured to communicate over a 5 GHz WLAN band.

In other aspects, WLAN radio 172 may be configured to communicate over any other additional or alternative wireless communication frequency bands.

In some demonstrative aspects, wireless communication IC 170 may include one or more other additional or alternative radios, for example, cellular radios, and/or any other type of radio.

In some demonstrative aspects, device 102 may include a controller 124, which may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controller 124 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controller 124. Additionally or alternatively, one or more functionalities of controller 124 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of BT radio 114 and/or WLAN radio 172.

In other aspects, the functionality of controller 124 may be implemented as part of any other element of device 102.

In some demonstrative aspects, controller 124 may include, operate as, perform a role of, and/or perform one or more functionalities of, a BT controller 169, which may be configured to control BT activities of BT radio 114, e.g., as described below.

In some demonstrative aspects, BT controller 169 may include, operate as, perform a role of, and/or perform one or more functionalities of, a BT scheduler, which may be configured to schedule the BT activities to BT radio 114, e.g., as described below.

In some demonstrative aspects, BT controller 169 may include, or may be implemented, partially or entirely, by circuitry and/or logic, e.g., one or more processors including circuitry and/or logic, memory circuitry and/or logic, MAC circuitry and/or logic, and/or any other circuitry and/or logic, configured to perform the functionality of BT controller 169. Additionally or alternatively, one or more functionalities of BT controller 169 may be implemented by logic, which may be executed by a machine and/or one or more processors, e.g., as described below.

In one example, BT controller 169 may include circuitry and/or logic, for example, one or more processors including circuitry and/or logic, to cause, trigger and/or control BT radio 114 to perform one or more operations, communications and/or functionalities, e.g., as described below. In one example, BT controller 169 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, message processor 128 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processor 128. Additionally or alternatively, one or more functionalities of message processor 128 may be implemented by logic, which may be executed by a machine and/or one or more processors, e.g., as described below.

In some demonstrative aspects, at least part of the functionality of message processor 128 may be implemented as part of BT radio 114 and/or WLAN radio 172.

In some demonstrative aspects, at least part of the functionality of message processor 128 may be implemented as part of controller 124.

In other aspects, the functionality of message processor 128 may be implemented as part of any other element of device 102.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more BT radios 114. In one example, the chip or SoC may be configured to perform one or more functionalities of one or more WLAN radios 172. For example, the chip or SoC may include one or more elements of controller 124, one or more elements of message processor 128, one or more elements of one or more radios BT 114, and/or one or more elements of one or more WLAN radios 172. In one example, controller 124, message processor 128, one or more BT radios 114 and one or more WLAN radios 172 may be implemented as part of the chip or SoC.

In other aspects, controller 124, message processor 128, one or more BT radios 114 and/or one or more WLAN radios 172 may be implemented by one or more additional or alternative elements of device 102.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a Wi-Fi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a Wi-Fi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, e.g., an IEEE 802.11-2020 Specification, and/or any other specification and/or protocol.

In some demonstrative aspects, device 102, device 140, and/or device 160 may be configured to implement one or more settings, features, operations and/or functionalities for BT communication in accordance with one or more protocols and/or standards, for example, in accordance with one or more Bluetooth Specifications.

In some demonstrative aspects, device 102, device 140, and/or device 160 may be configured to implement one or more settings, features, operations and/or functionalities for WLAN communication in accordance with one or more protocols and/or standards, for example, in accordance with one or more IEEE 802.11 Standards.

For example, in some implementations, scenarios, use cases, and/or deployments, controlling BT communications of a BT radio according to a predefined setting may be inefficient and/or may affect performance.

For example, BT communications may be configured to operate in a 2.4 GHz band, which may have at least a partial overlap with a frequency band utilized for WLAN communications, e.g., a WLAN 2.4 GHz band.

For example, various coexistence mechanisms may be implemented to support coexistence between a BT radio and a WLAN radio. For example, various inbuilt coexistence schemes may be configured for time sharing between the BT radio and the WLAN radio.

For example, in some implementations, coexistence algorithms may be biased towards Bluetooth and link sustainability.

For example, some built-in coexistence schemes for Bluetooth and WLAN time sharing, e.g., static coexistence schemes, may be inefficient and/or may result in degraded performance. For example, in some static coexistence algorithms, the WLAN throughput may be sacrificed, e.g., to allow better Bluetooth experience. For example, these built-in coexistence schemes may result in poor WLAN performance, e.g., poor WLAN throughput, for example, in complex Bluetooth time sharing use cases.

For example, many coexistence mechanisms may be configured as built in mechanisms, which may be built in a particular wireless communication device. For example, such built in mechanisms may provide a limited solution, e.g., as complex algorithms may not be applied, for example, due to real time constraints and/or resource limitations of the wireless communication device.

For example, a built-in coexistence embedded controller, which may be configured to support Bluetooth/Wi-Fi co-existence, may be limited in processing time and, accordingly, may limit performance of a system decision making.

In some demonstrative aspects, device 102, device 140, and/or device 160 may be configured to implement one or more operations and/or functionalities of a BT parameter-setting mechanism, which may be configured to support a server-based setting of one or more BT parameters for one or more BT devices, e.g., as described below.

In some demonstrative aspects, the BT parameter-setting mechanism may be configured to provide a technical solution to support a server-based setting of one or more BT parameters to be used by device 102, device 140, device 160, and/or one or more other wireless communication devices to communicate one or more BT transmissions, e.g., as described below.

In some demonstrative aspects, device 102, device 140, and/or device 160 may be configured to implement one or more operations and/or functionalities of a BT parameter-setting mechanism, which may be configured to provide a technical solution to support a BT/WLAN coexistence scheme, which may configure one or more BT parameters for a timing of BT transmissions, e.g., as described below.

In some demonstrative aspects, device 102, device 140, and/or device 160 may be configured to implement one or more operations and/or functionalities of a server-based BT parameter-setting mechanism, which may be configured to provide a technical solution to support setting of one or more BT parameters for a BT device, for example, based on BT parameter-setting information from a server, e.g., as described below.

In some demonstrative aspects, system 100 may include a parameter-setting server 180, which may be configured to provide BT parameter-setting information to one or more BT devices, e.g., device 102, device 140, and/or device 160, e.g., as described below.

In some demonstrative aspects, parameter-setting server 180 may be hosted as part of a wireless communication service.

In other aspects, parameter-setting server 180 may be implemented as a separate, e.g., dedicated, service, for example, as a separate cloud service, and/or as part of any other additional or alternative service or framework.

In some demonstrative aspects, parameter-setting server 180 may include, for example, a processor 171, a memory unit 174, and/or a storage unit 175. The parameter-setting server 180 may optionally include other suitable hardware components and/or software components. In some demonstrative aspects, some or all of the components of parameter-setting server 180 may be enclosed in a common housing or packaging, and may be interconnected or operably associated using one or more wired or wireless links. In other aspects, components of one or more of parameter-setting server 180 may be distributed among multiple or separate devices.

In some demonstrative aspects, processor 171 may include, for example, a CPU, a Graphics Processing Unit (GPU), an Auxiliary Processing Unit (xPU), a Neural Processing Unit (NPU), a DSP, one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 171 may execute instructions, for example, of an OS of parameter-setting server 180 and/or of one or more suitable applications.

In some demonstrative aspects, memory unit 174 includes, for example, a RAM, a ROM, a DRAM, an SD-RAM, a flash memory, a volatile memory, a non-volatile memory, a cache memory, a buffer, a short term memory unit, a long term memory unit, or other suitable memory units. Storage unit 175 may include, for example, a hard disk drive, a disk drive, an SSD, and/or other suitable removable or non-removable storage units. Memory unit 174 and/or storage unit 175, for example, may store data processed by parameter-setting server 180. Memory unit 174 and/or storage unit 175, for example, may store data processed by parameter-setting server 180.

In some demonstrative aspects, parameter-setting server 180 may include one or more communication interfaces 178 configured to communicate with one or more devices, e.g., device 102, device 140, and/or device 160, and/or any other additional or alternative element and/or device of system 100. For example, the one or more communication interfaces 178 may include one or more wireless communication interfaces, e.g., including one or more radios, to communicate over one or more wireless communication networks, and/or one or more wired communication interfaces to communicate over one or more wired networks.

In some demonstrative aspects, parameter-setting server 180 may include a controller 164. Controller 164 may be configured to perform and/or to trigger, cause, instruct and/or control parameter-setting server 180 to perform, one or more communications, to generate and/or communicate one or more messages and/or transmissions, and/or to perform one or more functionalities, operations and/or procedures between parameter-setting server 180, devices 102, 140, 160 and/or one or more other devices, e.g., as described below.

In some demonstrative aspects, controller 164 include, or may be implemented, partially or entirely, by circuitry and/or logic, e.g., one or more processors including circuitry and/or logic, memory circuitry and/or logic, and/or any other circuitry and/or logic, configured to perform the functionality of controller 164. Additionally or alternatively, one or more functionalities of controller 164 may be implemented by logic, which may be executed by a machine and/or one or more processors, e.g., as described below.

In one example, controller 164 may include circuitry and/or logic, for example, one or more processors including circuitry and/or logic, to cause, trigger and/or control a server, e.g., parameter-setting server 180, to perform one or more operations, communications and/or functionalities, e.g., as described herein. In one example, controller 164 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, parameter-setting server 180 may include a message processor 168 configured to generate, process and/or access one or messages communicated by parameter-setting server 180.

In one example, message processor 168 may be configured to generate one or more messages to be transmitted by parameter-setting server 180, and/or message processor 168 may be configured to access and/or to process one or more messages received by parameter-setting server 180, e.g., as described below.

In one example, message processor 168 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 168 may be configured to perform any other additional or alternative functionality and/or may include any other additional or alternative components to generate and/or process a message to be transmitted.

In some demonstrative aspects, message processor 168 may include, or may be implemented, partially or entirely, by circuitry and/or logic, e.g., one or more processors including circuitry and/or logic, memory circuitry and/or logic, and/or any other circuitry and/or logic, configured to perform the functionality of message processor 168. Additionally or alternatively, one or more functionalities of message processor 168 may be implemented by logic, which may be executed by a machine and/or one or more processors, e.g., as described below.

In some demonstrative aspects, at least part of the functionality of message processor 168 may be implemented as part of controller 164. In other aspects, the functionality of message processor 168 may be implemented as part of any other element of parameter-setting server 180.

In some demonstrative aspects, parameter-setting server 180 may be implemented as an entity, e.g., a cloud entity, which may be implemented in a cloud, for example, to provide information to devices 102, 140, 160 and/or one or more other devices, e.g., as described below.

In some demonstrative aspects, parameter-setting server 180 may be configured to provide one or more functionalities and/or operations of a centralized database, for example, to provide a feature parametrization, e.g., as a centralized feature parameterization entity and/or a feature control entity, e.g., as described below.

In some demonstrative aspects, parameter-setting server 180 may be configured to implement one or more operations and/or functionalities of a BT parameter-setting mechanism, which may be configured to maintain, manage, and/or distribute to devices of system 100, e.g., devices 102, 140 and/or 160, information corresponding to BT parameters, which may be implemented by one or more BT radios of devices of system 100, e.g., as described below.

In some demonstrative aspects, the BT parameter-setting mechanism may be configured to configure one or more BT parameters for a BT/WLAN coexistence scheme, e.g., as described below.

In some demonstrative aspects, the BT parameter-setting mechanism may be configured to configure one or more BT parameters for one or more additional or alternative BT functionalities and/or mechanisms, e.g., as described below.

In some demonstrative aspects, parameter-setting server 180 may be configured to implement one or more operations and/or functionalities of a BT parameter-setting mechanism, which may be configured to utilize one or more Artificial Intelligence (AI) techniques, for example, to utilize appropriate data for network optimization, e.g., as described below.

In some demonstrative aspects, parameter-setting server 180 may be configured to collect a vast amount of data, e.g., BT performance data, from many BT devices, e.g., including BT devices 102, 140, and/or 160, e.g., as described below.

In some demonstrative aspects, parameter-setting server 180 may be configured to utilize computation resources of AI Machine Learning (ML) (AIML) mechanisms, for example, to provide a technical solution to support offloading of a BT parameter setting functionality, e.g., a BT/WLAN coexistence windowing scheme and/or any other BT parameter setting functionality, to an AI Personalized Learning (AIPL) service, a Graphics Processing Unit (GPU) service, telemetry service, and/or any other additional or alternative AI service, which may be implemented at parameter-setting server 180, e.g., as described below.

In some demonstrative aspects, device 102, device 140, and/or device 160 may be configured to implement one or more operations and/or functionalities of a BT parameter-setting mechanism, which may be configured to support a systematic approach to use telemetry data and/or AI, e.g., on the Internet, for example, to build coexistence parameters for a BT KILL functionality, for example, in order to improve time sharing, for example, without substantially impacting Bluetooth performance, e.g., as described below.

In some demonstrative aspects, the BT parameter-setting mechanism may be configured to provide a technical solution to support utilizing telemetry data on decision making for dynamic co-existence windowing between Bluetooth and Wi-Fi, e.g., as described below.

For example, the BT parameter-setting mechanism may be configured to provide a technical solution for server-based setting of BT parameters, which may be scalable to various decision-making areas, for example, scheduling decisions, link quality decisions, e.g., for dynamic changes in the PHY, data rate, and/or any other decision-making mechanisms.

In some demonstrative aspects, parameter-setting server 180 may be configured to utilize processing resources, e.g., including an AI-enabled PC (AIPC) Neural Processing Unit (NPU) and/or an AIPC Graphics Processing Unit (GPU), which may be used to train a model for the server based setting of the BT parameters, for example, to optimize decisions for BT/Wi-Fi coexistence, e.g., as described below.

For example, the BT parameter-setting mechanism may be configured to support BT parameter settings based on framework inputs (also referred to as “model inputs”), which may be provided to the ML mechanism, and may include telemetry data which may vary from use case to use case.

In some demonstrative aspects, device 102, device 140, and/or device 160 may be configured to implement one or more operations and/or functionalities of a BT parameter-setting mechanism, which may be configured to support a dynamic coexistence windowing scheme, for example, to provide a technical solution for improved WLAN throughput with Bluetooth coexistence, e.g., as described below.

In some demonstrative aspects, device 102, device 140, and/or device 160 may be configured to implement one or more operations and/or functionalities of a BT parameter-setting mechanism, which may be configured to utilize non-real time decision-making schemes, e.g., using AIPC/NPU processing schemes, which may be implemented by the parameter-setting server 180. For example, the non-real time decision-making schemes may be configured based on telemetry data. For example, the non-real time decision-making schemes may be implemented to configure ML algorithms to be applied to current, e.g., real-time, data of a BT link. For example, the parameter-setting server 180 may be configured to utilize the ML algorithms to provide a setting of one or more BT parameters for a BT link, e.g., a BT link of device 102, for example, to optimize performance, e.g., as described below.

In some demonstrative aspects, the BT parameter-setting mechanism may be configured to provide a technical solution to support a low processing capability of an embedded system at a BT device, e.g., BT device 102, by improved processing capabilities, e.g., of an NPU, which may be implemented by the parameter-setting server 180, for example, to assist a real time system with timely decision-making, e.g., as described below.

In some demonstrative aspects, the BT parameter-setting mechanism may be configured to utilize one or more other algorithms, for example, heavy lifting algorithms, to support one or more additional or alternative real-time BT functionalities, for example, channel selection, link quality, scheduler schemes, and/or any other additional or alternative algorithm and/or scheme.

In some demonstrative aspects, device 102, device 140, and/or device 160 may be configured to implement one or more operations and/or functionalities of a BT parameter-setting mechanism, which may be configured to support dynamic time-sharing scheme for Wi-Fi and BT, for example, based on telemetry data from one or more wireless communication devices, e.g., as described below.

In some demonstrative aspects, device 102, device 140, and/or device 160 may be configured to implement one or more operations and/or functionalities of a BT parameter-setting mechanism, which may be configured to utilize one or more previous time-sharing patterns received from one or more wireless communication devices, e.g., as described below.

In some demonstrative aspects, device 102, device 140, and/or device 160 may be configured to implement one or more operations and/or functionalities of a BT parameter-setting mechanism, which may be configured to provide a technical solution to support setting of any other additional or alternative BT parameters for one or more additional or alternative BT functionalities, for example, link quality, bit rate switching, scheduling priorities, or the like.

In some demonstrative aspects, device 102, device 140, and/or device 160 may be configured to implement one or more operations and/or functionalities of a BT parameter-setting mechanism, which may be configured to support a server-based setting of one or more BT parameters to be implemented by a BT radio of a wireless communication device, for example, a BT radio 114, for example, based on parameter information provided from parameter-setting server 180, e.g., as described below.

In some demonstrative aspects, controller 124 may be configured to control, trigger, cause, and/or instruct wireless communication device 102 to send communication-based information (also referred to as “communication information”) to BT parameter-setting server 180, e.g., as described below.

In some demonstrative aspects, the communication-based information may be based on wireless communications communicated by the wireless communication device 102, e.g., as described below.

In some demonstrative aspects, controller 124 may be configured to control, trigger, cause, and/or instruct wireless communication device 102 to process BT parameter-setting information from the BT parameter-setting server 180 to identify a setting of one or more BT parameters to be implemented by a BT radio 114 of the wireless communication device 102, e.g., as described below.

In some demonstrative aspects, controller 124 may be configured to control, trigger, cause, and/or instruct wireless communication device 102 to configure a setting of the BT radio 114, for example, according to the setting of the one or more BT parameters, e.g., as described below.

In some demonstrative aspects, controller 124 may be configured to control, trigger, cause, and/or instruct wireless communication device 102 to send a message including the communication-based information to the BT parameter-setting server 180, e.g., as described below.

In some demonstrative aspects, controller 124 may be configured to control, trigger, cause, and/or instruct wireless communication device 102 to receive the BT parameter-setting information from BT parameter-setting server 180, for example, based on the message sent to the BT parameter-setting server 180, e.g., as described below.

In some demonstrative aspects, the BT parameter-setting information may include BT and WLAN (BT/WLAN) coexistence information to configure a BT/WLAN coexistence scheme, e.g., as described below.

In some demonstrative aspects, the one or more BT parameters, which are to be set according to the BT parameter-setting information, may be based, for example, on the BT/WLAN coexistence scheme, e.g., as described below.

In some demonstrative aspects, the BT/WLAN coexistence scheme may include a BT/WLAN time-sharing scheme, e.g., as described below.

In some demonstrative aspects, the one or more BT parameters, which are to be set according to the BT parameter-setting information, may include, for example, one or more BT timing parameters to configure a timing of BT transmissions to be communicated by the BT radio 114, for example, according to the BT/WLAN time-sharing scheme, e.g., as described below.

In some demonstrative aspects, the one or more BT timing parameters may include a BT time window parameter, e.g., as described below.

In other aspects, the one or more BT timing parameters may include any other additional or alternative timing parameters.

In some demonstrative aspects, the BT parameter-setting information may include BT PHY link information to configure a BT PHY link setting, e.g., as described below.

In some demonstrative aspects, the one or more BT parameters, which are to be set according to the BT parameter-setting information, may be based, for example, on the BT PHY link setting, e.g., as described below.

In some demonstrative aspects, the BT PHY link setting may include a BT link quality setting, e.g., as described below.

In some demonstrative aspects, the BT PHY link setting may include a BT data rate setting, e.g., as described below.

In other aspects, the BT PHY link setting may include any other additional or alternative BT PHY link setting.

In some demonstrative aspects, controller 124 may be configured to control, trigger, cause, and/or instruct wireless communication device 102 to send to BT parameter-setting server 180 the communication-based information, which may include information of one or more parameters affecting BT communications by the BT radio 114, e.g., as described below.

In some demonstrative aspects, the communication-based information may include BT information corresponding to BT transmissions communicated by the BT radio 114, e.g., as described below.

In some demonstrative aspects, the BT information may include BT profile information corresponding to a BT Tx profile of the BT transmissions, e.g., as described below.

In some demonstrative aspects, the BT information may include BT profile information corresponding to a BT Rx profile of the BT transmissions, e.g., as described below.

In some demonstrative aspects, the BT information may include BT profile information corresponding to a BT Tx and Rx profile of the BT transmissions, e.g., as described below.

In some demonstrative aspects, the BT information may include BT performance information corresponding to the BT transmissions, e.g., as described below.

In some demonstrative aspects, the BT performance information may include a BT Packet Error Rate (PER) corresponding to the BT transmissions, e.g., as described below.

In some demonstrative aspects, the BT PER may include a distance-based PER, e.g., as described below.

In some demonstrative aspects, the BT PER may include an environment-based PER, e.g., as described below.

In other aspects, the BT PER may include any other additional or alternative type of PER.

In some demonstrative aspects, the BT performance information may include a BT No Acknowledgement (NACK) rate corresponding to the BT transmissions, e.g., as described below.

In some demonstrative aspects, the BT performance information may include a BT no synchronization (no-sync) profile of BT no-sync messages, e.g., as described below.

In other aspects, the BT performance information may include any other additional or alternative information corresponding to the BT transmissions.

In some demonstrative aspects, the BT information may include BT coder/decoder (codec) information corresponding to a BT codec for the BT transmissions, e.g., as described below.

In some demonstrative aspects, the BT information may include BT Tx power information corresponding to a Tx power for the BT transmissions, e.g., as described below.

In some demonstrative aspects, the BT information may include BT traffic-based information, which may be based, for example, on a type of BT traffic communicated by the BT radio 114, e.g., as described below.

In other aspects, the BT information may include any other additional or alternative information corresponding to the BT transmissions communicated by the BT radio 114.

In some demonstrative aspects, controller 124 may be configured to control, trigger, cause, and/or instruct wireless communication device 102 to send to BT parameter-setting server 180 the communication-based information, which may include WLAN information corresponding to WLAN transmissions communicated by a WLAN radio 172 of wireless communication device 102, e.g., as described below.

In some demonstrative aspects, the WLAN information may include WLAN profile information corresponding to a WLAN Tx profile of the WLAN transmissions, e.g., as described below.

In some demonstrative aspects, the WLAN information may include WLAN performance information corresponding to the WLAN transmissions, e.g., as described below.

In some demonstrative aspects, the WLAN information may include WLAN Transmission (Tx) window information corresponding to one or more WLAN Tx windows for the WLAN transmissions, e.g., as described below.

In some demonstrative aspects, the WLAN information may include AP information corresponding to a WLAN AP to handle the WLAN transmissions, e.g., as described below.

In other aspects, the WLAN information may include any other additional or alternative information corresponding to the WLAN transmissions communicated by the WLAN radio 172 of the wireless communication device 102.

In some demonstrative aspects, controller 124 may be configured to control, trigger, cause, and/or instruct wireless communication device 102 to send first communication-based information to BT parameter-setting server 180, e.g., as described below.

In some demonstrative aspects, controller 124 may be configured to control, trigger, cause, and/or instruct wireless communication device 102 to process first BT parameter-setting information received from BT parameter-setting server 180, for example, based on the first communication-based information, for example, to identify a first setting of the one or more BT parameters to be implemented by the BT radio 114, e.g., as described below.

In some demonstrative aspects, controller 124 may be configured to control, trigger, cause, and/or instruct wireless communication device 102 to configure a first setting of the BT radio 114, for example, according to the first setting of the one or more BT parameters, e.g., as described below.

In some demonstrative aspects, controller 124 may be configured to control, trigger, cause, and/or instruct wireless communication device 102 to send second communication-based information, e.g., different from the first communication-based information, to the BT parameter-setting server 180, e.g., as described below.

In some demonstrative aspects, controller 124 may be configured to control, trigger, cause, and/or instruct wireless communication device 102 to process second BT parameter-setting information received from BT parameter-setting server 180, for example, based on the second communication-based information, for example, to identify a second setting of the one or more BT parameters, e.g., different from the first setting of the one or more BT parameters, e.g., as described below.

In some demonstrative aspects, controller 124 may be configured to control, trigger, cause, and/or instruct wireless communication device 102 to configure a second setting of the BT radio 114, for example, according to the second setting of the one or more BT parameters, e.g., as described below.

In some demonstrative aspects, controller 124 may be configured to control, trigger, cause, and/or instruct wireless communication device 102 to send device characteristic information to BT parameter-setting server 180, e.g., as described below.

In some demonstrative aspects, the device characteristic information from the wireless communication device 102 may correspond to one or more characteristics of the wireless communication device 102, e.g., as described below.

In some demonstrative aspects, controller 124 may be configured to control, trigger, cause, and/or instruct wireless communication device 102 to identify the BT parameter-setting information from the parameter-setting server 180, which may be based, for example, on the device characteristic information from the wireless communication device 102, e.g., as described below.

In some demonstrative aspects, the device characteristic information from the wireless communication device 102 may include, for example, device type information to identify a type of the wireless communication device 102, e.g., as described below.

In some demonstrative aspects, the device characteristic information from the wireless communication device 102 may include, for example, manufacturer information to identify a manufacturer of the wireless communication device 102, e.g., as described below.

In other aspects, the device characteristic information from the wireless communication device 102 may include any other additional or alternative type of information corresponding to one or more characteristics of the wireless communication device 102.

In some demonstrative aspects, controller 164 may be configured to control, trigger, cause, and/or instruct BT parameter-setting server 180 to determine BT parameter-setting information for a wireless communication device, for example, based on communication-based information from the wireless communication device, e.g., as described below.

For example, the communication-based information from the wireless communication device may include the communication-based information sent from wireless communication device 102, e.g., as described above.

In some demonstrative aspects, the communication-based information may be based on wireless communications communicated by the wireless communication device, e.g., wireless communication device 102, from which the communication-based information is received, e.g., as described below.

In some demonstrative aspects, the BT parameter-setting information for the wireless communication device may include information to configure a setting of one or more BT parameters to be implemented by a BT radio of the wireless communication device, e.g., as described below.

In some demonstrative aspects, controller 164 may be configured to control, trigger, cause, and/or instruct BT parameter-setting server 180 to send the BT parameter-setting information to the wireless communication device, e.g., as described below.

In some demonstrative aspects, controller 164 may be configured to control, trigger, cause, and/or instruct BT parameter-setting server 180 to determine the BT parameter-setting information for the wireless communication device, for example, based on other BT parameter-setting information from one or more other wireless communication devices, e.g., as described below.

In some demonstrative aspects, the other BT parameter-setting information may be based on wireless communications communicated by the one or more other wireless communication devices, e.g., as described below.

For example, BT parameter-setting server 180 may determine the BT parameter-setting information for wireless communication device 102, for example, based on BT parameter-setting information from wireless communication device 140, and/or based on BT parameter-setting information from wireless communication device 160.

In some demonstrative aspects, controller 164 may be configured to control, trigger, cause, and/or instruct BT parameter-setting server 180 to send first BT parameter-setting information to a first wireless communication device, for example, based on first communication-based information from the first wireless communication device, e.g., as described below.

In some demonstrative aspects, the first BT parameter-setting information may be configured, for example, to configure a first setting of one or more first BT parameters to be implemented by a BT radio of the first wireless communication device, e.g., as described below.

In some demonstrative aspects, controller 164 may be configured to control, trigger, cause, and/or instruct BT parameter-setting server 180 to send second BT parameter-setting information to a second wireless communication device, for example, based on second communication-based information from the second wireless communication device, e.g., as described below.

In some demonstrative aspects, the second BT parameter-setting information may be configured, for example, to configure a second setting of one or more second BT parameters to be implemented by a BT radio of the second wireless communication device, e.g., as described below.

In some demonstrative aspects, the second setting of the one or more second BT parameters to be implemented by the BT radio of the second wireless communication device may be different from the first setting of the one or more first BT parameters to be implemented by the BT radio of the first wireless communication device, e.g., as described below.

For example, BT parameter-setting server 180 may send first BT parameter-setting information to wireless communication device 102, for example, based on communication-based information from wireless communication device 102. For example, the first BT parameter-setting information may be configured to configure a first setting of one or more first BT parameters to be implemented by a BT radio 114 of wireless communication device 102.

For example, BT parameter-setting server 180 may send second BT parameter-setting information to wireless communication device 140, for example, based on communication-based information from device 140. For example, the second BT parameter-setting information may be configured to configure a second setting of one or more second BT parameters, e.g., different from the first setting, to be implemented by a BT radio of wireless communication device 140.

In some demonstrative aspects, controller 164 may be configured to control, trigger, cause, and/or instruct BT parameter-setting server 180 to generate the BT parameter-setting information for the wireless communication device based, for example, on a Machine-Learning (ML) output of an ML algorithm trained to generate the ML output, for example, based on a ML input, e.g., as described below.

In some demonstrative aspects, the ML input may be based, for example, on the communication-based information from the wireless communication device, e.g., as described below.

In some demonstrative aspects, controller 164 may be configured to control, trigger, cause, and/or instruct BT parameter-setting server 180 to determine the BT parameter-setting information for the wireless communication device, e.g., wireless communication device 102, for example, based on device characteristic information from the wireless communication device, e.g., as described below.

In some demonstrative aspects, wireless communication device 102 and/or BT parameter-setting server 180 may be configured to implement one or more operations and/or functionalities of a BT parameter-setting mechanism, which may be configured to support dynamic decision making for a setting of one or more BT parameters, for example, a setting of one or more BT parameters for a Bluetooth window and/or a WLAN window in a time division multiplexing scheme, e.g., as described below.

In some demonstrative aspects, wireless communication device 102 and/or BT parameter-setting server 180 may be configured to implement one or more operations and/or functionalities of a BT parameter-setting mechanism, which may be configured to support a setting of one or more BT parameters for wireless communication device 102, for example, based on BT information, WLAN information and/or any other additional or alternative information related to wireless communication device 102, e.g., as described below.

In one example, BT parameter-setting server 180 may receive from one or wireless communication devices, for example, from wireless communication device 102, device 140 and/or device 160, data corresponding to wireless communication performed by the one or more wireless communication devices. For example, the data received by BT parameter-setting server 180 may include one or more of the following parameters corresponding to a wireless communication device:
Bluetooth headset role, e.g., to indicate a role of a BT device implemented by the wireless communication device.
Bluetooth Audio codec selected, e.g., to indicate a selected codec to be implemented by the BT device implemented by the wireless communication device.
Codec configured bit rate, e.g., to indicate a codec bit rate implemented by the BT device implemented by the wireless communication device.
Packet Error Rate (PER) due to distance, e.g., to indicate a PER due to distance for the BT device implemented by the wireless communication device.
PER due to environment, e.g., to indicate a PER due to environment for the BT device implemented by the wireless communication device.
Transmit power, e.g., to indicate a Tx power for the BT device implemented by the wireless communication device.
No acknowledgement rate, e.g., to indicate a NACK rate for the BT device implemented by the wireless communication device.
A Wi-Fi windowing start time in a Time-Division Multiplexing (TDM) scheme, e.g., to indicate a start time of a Wi-Fi window for a WLAN STA implemented by the wireless communication device.
Type of Wi-Fi traffic, e.g., to indicate WLAN traffic of the WLAN STA implemented by the wireless communication device.
Access point behavior, e.g., to indicate an AP behavior of an AP for the WLAN STA implemented by the wireless communication device.
Any other additional or alternative information corresponding to the BT functionality of the BT device implemented by the wireless communication device, and/or any other additional or alternative information corresponding to the WLAN functionality of the WLAN STA device implemented by the wireless communication device.

For example, wireless communication device 102 may send to BT parameter-setting server 180 first communication-based information, which may include one or more of the parameters described above as determined and/or measured at the wireless communication device 102.

For example, wireless communication device 140 may send to BT parameter-setting server 180 second communication-based information, which may include one or more of the parameters described above as determined and/or measured at the wireless communication device 140.

For example, BT parameter-setting server 180 may determine first BT parameter-setting information, for example, based on the first communication-based information from wireless communication device 102. For example, BT parameter-setting server 180 may send the first BT parameter-setting information to wireless communication device 102. For example, the first BT parameter-setting information may configure a first setting of one or more first BT parameters to be implemented by a BT radio 114 of wireless communication device 102.

For example, BT parameter-setting server 180 may determine second BT parameter-setting information, for example, based on the second communication-based information from wireless communication device 140. For example, BT parameter-setting server 180 may send the second BT parameter-setting information to wireless communication device 140. For example, the second BT parameter-setting information may configure a second setting of one or more second BT parameters to be implemented by a BT radio of wireless communication device 140.

In some demonstrative aspects, wireless communication device 102 and/or BT parameter-setting server 180 may be configured to implement one or more operations and/or functionalities of a BT parameter-setting mechanism, which may be configured to address one or more limitations of an embedded controller in decision-making, e.g., as described below.

In some demonstrative aspects, BT parameter-setting server 180 may be configured to implement one or more operations and/or functionalities of a BT parameter-setting mechanism, which may be configured to support centralized processing of communication-based information (also referred to as “telemetry data”) received from one or more wireless communication devices, e.g., as described below.

In some demonstrative aspects, the BT parameter-setting mechanism may be configured to support one or more ML algorithms, for example, to process the telemetry data received from the one or more wireless communication devices, e.g., as described below.

In some demonstrative aspects, the BT parameter-setting mechanism may be configured to support offloading a processing of the telemetry data to one or more ML algorithms, which may be executed, for example, by a Neural Processing Unit (NPU), an AI-enabled PC (AIPC), and/or any other suitable processing mechanism, e.g., as described below.

For example, BT parameter-setting server 180 may generate BT parameter-setting information for a wireless communication device, for example, based on an ML output of an ML algorithm trained to generate the ML output based on an ML input, which may be based on telemetry data received from the wireless communication device.

For example, the ML algorithm may be trained based on telemetry data received from a plurality of wireless communication devices, e.g., including wireless communication devices 102, 140 and/or 160.

For example, the ML algorithm may be configured to utilize multiple ML inputs from multiple wireless communication devices.

For example, the plurality of ML inputs to the ML algorithm may be based on telemetry data gathered across multiple networks and/or systems, e.g., according to a crowd sourcing mechanism.

In one example, BT parameter-setting server 180 may be configured to process traffic flow data, for example, including bitrate requirements for a Bluetooth use case, e.g., Advanced Audio Codec (AAC), e.g., at 192 kilobyte per second (kbps), Lossless Digital Audio Codec (LDAC), e.g., at 1 megabyte per second (Mbps), and/or any other additional or alternative requirements.

In some demonstrative aspects, wireless communication device 102 and/or BT parameter-setting server 180 may be configured to implement one or more operations and/or functionalities of a BT parameter-setting mechanism, which may be configured to support one or more of the following coexistence schemes:
Static time-sharing scheme, e.g., a window-based coexistence scheme.
Dynamic window for Bluetooth and Wi-Fi.
Allow BT to stop Wi-Fi Tx any time, e.g., according to an interrupt-based coexistence scheme.
Allow concurrent Tx, which includes allowing both Wi-Fi and BT transmissions.
Any other additional or alternative coexistence scheme.

In some demonstrative aspects, BT parameter-setting server 180 may be configured to implement one or more operations and/or functionalities of a BT parameter-setting mechanism, which may be configured to support generating BT/WLAN coexistence information for a wireless communication device, for example, based on one or more of ML outputs of an ML algorithm, e.g., as described below.

For example, the BT/WLAN coexistence information may include a WLAN to Bluetooth ratio, which may indicate, for example, a duration of a Wi-Fi interval, e.g., per every 100 msec interval.

For example, the BT/WLAN coexistence information may include a start time of a grant window, which may indicate, for example, a window to communicate BT communications.

For example, the BT/WLAN coexistence information may include an adjustment window duration, e.g., in units of time (msec).

In other aspects, the BT/WLAN coexistence information may include a setting of any other additional or alternative parameter to support and/or configure a BT /LAN coexistence scheme.

For example, BT parameter-setting server 180 may be configured to utilize the ML algorithm to generate the one or more of ML outputs to configure a setting of one or more BT parameters for a wireless communication device, for example, based on communication-based information (also referred to as “telemetry data”) received from the wireless communication device, e.g., wireless communication device 102.

In one example, controller 124 may be configured to perform one or more functionalities, operations and/or procedures of a BT/WLAN coexistence manager, which may collect and send to BT parameter-setting server 180 telemetry data including one or more of the following information types:
BT Tx and/or Rx packet information.
BT Rx no-sync profile of BT no-sync messages.
BT Tx NACK rate corresponding to BT transmissions.
BT Tx and Rx profile of BT transmissions.
Wi-Fi Tx profile of WLAN transmissions.
Any other additional or alternative telemetry data.

For example, a pattern of an Advanced Audio Distribution Profile (A2DP) packet data may be characterized by switching to basic polling (POLL) POLL/NULL for a particular period of time, e.g., 20 milliseconds (msec) or any other period of time. For example, after the particular period of time audio data transmission may restart.

For example, setting a WLAN Tx window based on an end of the A2DP packet data, e.g., such that the WLAN Tx window may substantially match the end of the A2DP packet data, may improve Wi-Fi throughput and, as a result, may improve overall system performance. For example, Wi-Fi throughput may be degraded, in case the WLAN Tx window is not used properly.

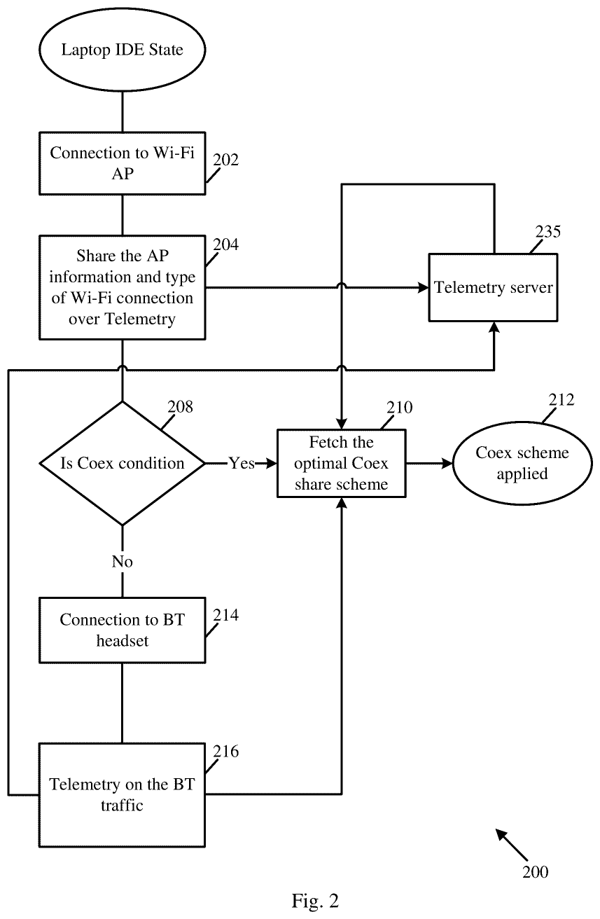

Reference is made to FIG. 2, which schematically illustrates a method 200 of BT parameter-setting, in accordance with some demonstrative aspects.

For example, device 102 (FIG. 1), device 140 (FIG. 1), device 160 (FIG. 1), and/or BT parameter-setting server 180 (FIG. 1) may be configured to implement one or more operations and/or functionalities of the method of FIG. 2.

In some demonstrative aspects, as indicated at block 202, the method may include establishing at a wireless communication device a Wi-Fi connection with a WLAN AP.

In some demonstrative aspects, as indicated at block 204, the method may include sending WLAN information from the wireless communication device to a BT parameter-setting server (also referred to as “telemetry server”) 235, for example, over telemetry.

For example, the WLAN information may include AP information corresponding to an AP of the Wi-Fi connection, information on a type of the Wi-Fi connection, and/or any other suitable information corresponding to the Wi-Fi connection.

For example, the WLAN information may include a Wi-Fi profile and/or Tx, Rx information, which may be available to a coexistence manager of the wireless communication device.

In some demonstrative aspects, as indicated at block 208, the method may include determining whether a coexistence condition is fulfilled at the wireless communication device.

In some demonstrative aspects, as indicated at block 210, the method may include fetching from the BT parameter-setting server 235 BT/WLAN coexistence information to configure a BT/WLAN coexistence scheme for the wireless communication device. For example, the BT/WLAN coexistence information may configure a setting of one or more BT parameters based on the BT/WLAN coexistence scheme, e.g., as described above.

In some demonstrative aspects, as indicated at block 212, the method may include configuring at the wireless communication device a BT/WLAN coexistence scheme according to the BT/WLAN coexistence information received from the. BT parameter-setting server 235.

In some demonstrative aspects, as indicated at block 214, the method may include connecting a BT device of the wireless communication device to another BT device, for example, over a BT link.

In some demonstrative aspects, as indicated at block 216, the method may include sending BT communication-based information from the wireless communication device to the BT parameter-setting server 235. For example, the BT communication-based information may be based on BT communications communicated by the BT device of the wireless communication device, e.g., as described above.

For example, the coexistence manager of the wireless communication device may be configured to send to the BT parameter-setting server 235 BT telemetry information including, for example, BT Tx timing information, BT Rx timing information, BT profile information, BT ACK information, BT NACK information, BT No-Sync information, and/or any other suitable information.

In some demonstrative aspects, the BT parameter-setting server 235 may be configured to collect communication-based information, e.g., including BT information and/or WLAN information, from multiple wireless communication devices, e.g., across multiple use cases, for example, to form a large amount of telemetry data that may be available on an exterior entity, for example, a cloud service.

In some demonstrative aspects, the BT parameter-setting server 235 may be configured to train one or more ML algorithms based on the collected telemetry data.

In some demonstrative aspects, the ML algorithms may be configured to determine a setting of one or more BT parameters, for example, one or more BT/WLAN coexistence parameters, one or more BT PHY link parameters, or the like.

In some demonstrative aspects, the ML algorithms may be configured to determine a setting of one or more BT parameters, for example, for various BT/WLAN sharing mechanisms, for example, to provide a technical solution to support optimal BT/WLAN sharing.

For example, as shown in FIG. 2, a wireless communication device may send to the BT parameter-setting server 235 the communication-based information corresponding to the wireless communications performed by the wireless communication device.

For example, as shown in FIG. 2, the wireless communication device may fetch from the BT parameter-setting server 235 BT parameter-setting information to determine a setting of one or more BT parameters to be implemented by the wireless communication device, for example, when the wireless communication device connects to a Wi-Fi AP or enters into a Bluetooth use case.

For example, BT parameter-setting information may be determined by the BT parameter-setting server 235, for example, to configure an optimal BT/WLAN time share for the wireless communication device.

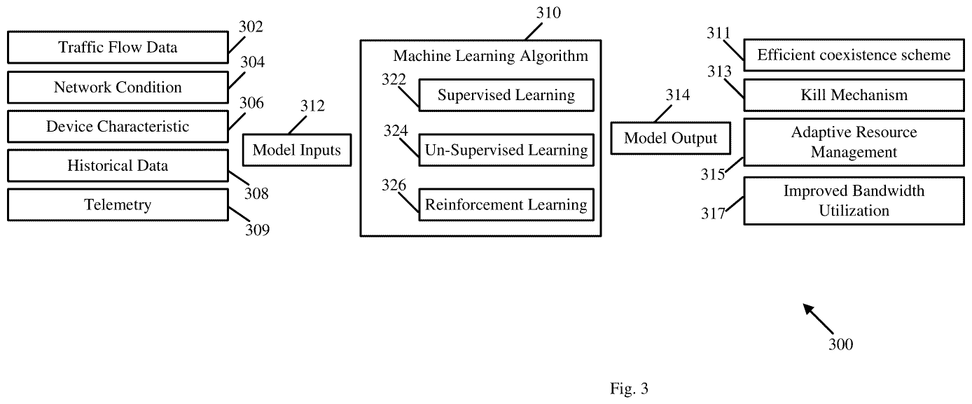

Reference is made to FIG. 3, which schematically illustrates a ML-based BT parameter-setting mechanism 300, in accordance with some demonstrative aspects.

For example, device 102 (FIG. 1), device 140 (FIG. 1), device 160 (FIG. 1), and/or BT parameter-setting server 180 (FIG. 1) may be configured to implement one or more operations and/or functionalities of the ML-based BT parameter-setting mechanism 300.

For example, BT parameter-setting server 180 (FIG. 1) may be configured to implement one or more operations and/or functionalities of the ML-based BT parameter-setting mechanism 300, to implement an ML algorithm 310, which may be trained to generate a model output 314, for example, based on one or more model inputs 312, e.g., as described below.

For example, model inputs 312 may be based on communication-based information from a wireless communication device, e.g., wireless communication device 102 (FIG. 1).

For example, as shown in FIG. 3, model inputs 312 may include traffic-based information 302 including traffic flow data, for example, which may be based on a type of BT traffic communicated by a BT radio of the wireless communication device, e.g., BT radio 114 (FIG. 1).

For example, as shown in FIG. 3, model inputs 312 may include network condition information 304 corresponding to one or more network conditions for communication of the BT traffic.

For example, as shown in FIG. 3, model inputs 312 may include device characteristic information 306 corresponding to one or more characteristics of the wireless communication device.

For example, as shown in FIG. 3, model inputs 312 may include historical data 308 corresponding to previous use cases.

For example, as shown in FIG. 3, model inputs 312 may include telemetry data 309, which may be collected from a plurality of wireless communication devices.

For example, as shown in FIG. 3, model output 314 may be configured to define one or more setting parameters, which may be configured, for example, to support an efficient coexistence scheme 311.

For example, as shown in FIG. 3, model output 314 may be configured to define one or more setting parameters, which may be configured, for example, to support a kill mechanism 313.

For example, as shown in FIG. 3, model output 314 may be configured to define one or more setting parameters, which may be configured, for example, to support an adaptive resource management mechanism 315.

For example, as shown in FIG. 3, model output 314 may be configured to define one or more setting parameters, which may be configured, for example, to support an improved bandwidth utilization 317.

In some demonstrative aspects, as shown in FIG. 3, machine learning algorithm 310 may include a supervised learning algorithm 322, e.g., as described below.

In some demonstrative aspects, supervised learning algorithm 322 may utilize one or more regression models, for example, to predict optimal window sizes and/or bandwidth allocation, for example, based on traffic patterns and/or network conditions.

In some demonstrative aspects, supervised learning algorithm 322 may utilize one or more classification models, for example, to identify traffic patterns that may lead to congestion and/or underutilization.

In other aspects, supervised learning algorithm 322 may utilize any other additional or alternative model.

In some demonstrative aspects, as shown in FIG. 3, machine learning algorithm 310 may include an un-supervised learning algorithm 324, e.g., as described below.

In some demonstrative aspects, un-supervised learning algorithm 324 may implement one or more operations and/or functionalities of a clustering algorithm, which may be configured to group similar traffic patterns, for example, to identify common scenarios and/or their optimal configurations.

In some demonstrative aspects, un-supervised learning algorithm 324 may implement one or more operations and/or functionalities of an anomaly detection algorithm, for example, to detect unusual traffic patterns that may require special handling.

In other aspects, un-supervised learning algorithm 324 may include any other additional or alternative algorithm.

In some demonstrative aspects, as shown in FIG. 3, machine learning algorithm 310 may include a reinforcement learning algorithm 324, e.g., as described below.

In some demonstrative aspects, reinforcement learning algorithm 324 may implement one or more operations and/or functionalities of one or more adaptive algorithms, for example, to continuously learn and adapt windowing strategies, for example, based on real-time feedback from network performance.

In other aspects, reinforcement learning algorithm 324 may include any other additional or alternative algorithm.

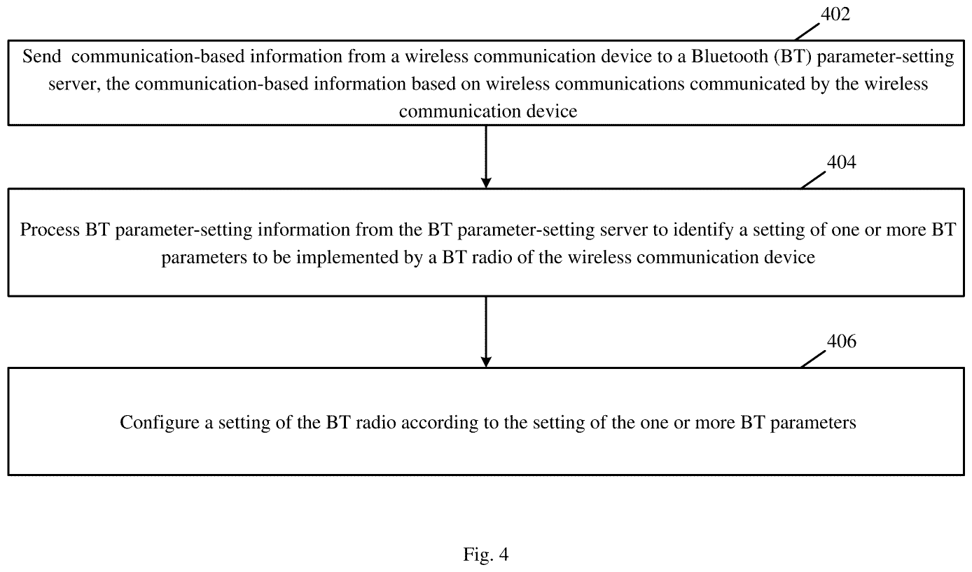

Reference is made to FIG. 4, which schematically illustrates a method of server-based setting of BT parameters, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1), device 140 (FIG. 1), and/or device 160 (FIG. 1), a server, e.g., parameter-setting server 180 (FIG. 1), a controller, e.g., controller 124 (FIG. 1) and/or controller 164 (FIG. 1), a radio, e.g., BT radio 114 (FIG. 1) and/or WLAN radio 172 (FIG. 1), and/or a message processor, e.g., message processor 128 (FIG. 1) and/or message processor 168 (FIG. 1).

As indicated at block 402, the method may include sending communication-based information from a wireless communication device to a BT parameter-setting server. For example, the communication-based information may be based on wireless communications communicated by the wireless communication device. For example, controller 124 (FIG. 1) may be configured to cause, trigger, and/or control wireless communication device 102 (FIG. 1) to send the communication-based information to BT parameter-setting server 180 (FIG. 1), e.g., as described above.

As indicated at block 404, the method may include processing BT parameter-setting information from the BT parameter-setting server to identify a setting of one or more BT parameters to be implemented by a BT radio of the wireless communication device. For example, controller 124 (FIG. 1) may be configured to cause, trigger, and/or control wireless communication device 102 (FIG. 1) to process BT parameter-setting information from the BT parameter-setting server 180 (FIG. 1) to identify a setting of one or more BT parameters to be implemented by BT radio 114 (FIG. 1) of wireless communication device 102 (FIG. 1), e.g., as described above.

As indicated at block 406, the method may include configuring a setting of the BT radio, for example, according to the setting of the one or more BT parameters. For example, controller 124 (FIG. 1) may be configured to cause, trigger, and/or control wireless communication device 102 (FIG. 1) to configure a setting of the BT radio 114 (FIG. 1), for example, according to the setting of the one or more BT parameters, e.g., as described above.

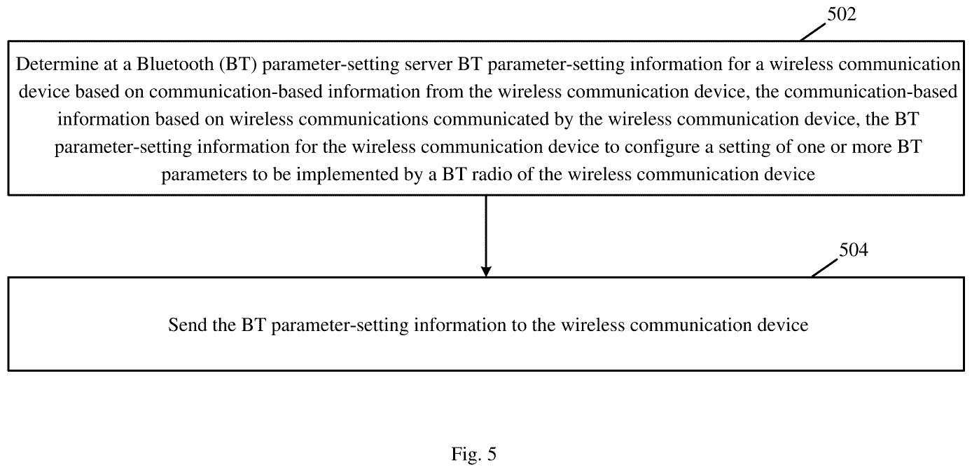

Reference is made to FIG. 5, which schematically illustrates a method of server-based setting of BT parameters, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), device 140 (FIG. 1), and/or device 160 (FIG. 1), a server, e.g., BT parameter-setting server 180 (FIG. 1), a controller, e.g., controller 124 (FIG. 1) and/or controller 164 (FIG. 1), a radio, e.g., BT radio 114 (FIG. 1) and/or WLAN radio 172 (FIG. 1), and/or a message processor, e.g., message processor 128 (FIG. 1) and/or message processor 168 (FIG. 1).

As indicated at block 502, the method may include determining, at a BT parameter-setting server, BT parameter-setting information for a wireless communication device, for example, based on communication-based information from the wireless communication device. For example, the communication-based information may be based on wireless communications communicated by the wireless communication device. For example, the BT parameter-setting information for the wireless communication device may configure a setting of one or more BT parameters to be implemented by a BT radio of the wireless communication device. For example, controller 164 (FIG. 1) may be configured to cause, trigger, and/or control BT parameter-setting server 180 (FIG. 1) to determine the BT parameter-setting information for wireless communication device 102 (FIG. 1), for example, based on the a information from the wireless communication device 102 (FIG. 1), e.g., as described above.

As indicated at block 504, the method may include sending the BT parameter-setting information to the wireless communication device. For example, controller 164 (FIG. 1) may be configured to cause, trigger, and/or control the BT parameter-setting server 180 (FIG. 1) to send the BT parameter-setting information to the wireless communication device 102 (FIG. 1), e.g., as described above.

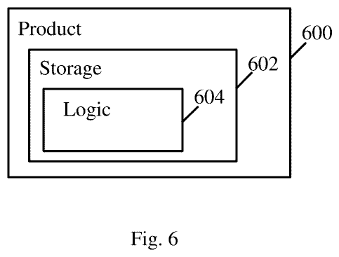

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), device 140 (FIG. 1), device 160 (FIG. 1), BT parameter-setting server 180 (FIG. 1), controller 124 (FIG. 1), controller 164 (FIG. 1), message processor 128 (FIG. 1), message processor 168 (FIG. 1), BT radio 114 (FIG. 1), WLAN radio 172 (FIG. 1), transmitter 118 (FIG. 1), and/or receiver 116 (FIG. 1); to cause device 102 (FIG. 1), device 140 (FIG. 1), device 160 (FIG. 1), BT parameter-setting server 180 (FIG. 1), controller 124 (FIG. 1), controller 164 (FIG. 1), message processor 128 (FIG. 1), message processor 168 (FIG. 1), BT radio 114 (FIG. 1), WLAN radio 172 (FIG. 1), transmitter 118 (FIG. 1), and/or receiver 116 (FIG. 1) to perform, trigger and/or implement one or more operations and/or functionalities; and/or to perform, trigger and/or implement one or more operations and/or functionalities described with reference to the FIGS. 1, 2, 3, 4, and/or 5, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 600 and/or machine readable storage media 602 may include one or more types of computer-readable storage media capable of storing data, including volatile memory, non-volatile memory, removable or non-removable memory, erasable or non-erasable memory, writeable or re-writeable memory, and the like. For example, machine readable storage media 402 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a wireless communication device to send communication information to a Bluetooth (BT) parameter-setting server, the communication information based on wireless communications communicated by the wireless communication device; process BT parameter-setting information from the BT parameter-setting server to identify a setting of one or more BT parameters to be implemented by a BT radio of the wireless communication device; and configure a setting of the BT radio according to the setting of the one or more BT parameters.

Example 2 includes the subject matter of Example 1, and optionally, wherein the BT parameter-setting information comprises BT and Wireless Local Area Network (WLAN) (BT/WLAN) coexistence information to configure a BT/WLAN coexistence scheme, wherein the one or more BT parameters are based on the BT/WLAN coexistence scheme.

Example 3 includes the subject matter of Example 2, and optionally, wherein the BT/WLAN coexistence scheme comprises a BT/WLAN time-sharing scheme, the one or more BT parameters comprising one or more BT timing parameters to configure a timing of BT transmissions to be communicated by the BT radio according to the BT/WLAN time-sharing scheme.

Example 4 includes the subject matter of Example 3, and optionally, wherein the one or more BT timing parameters comprises a BT time window parameter.

Example 5 includes the subject matter of any one of Examples 1-4, and optionally, wherein the BT parameter-setting information comprises BT Physical layer (PHY) link information to configure a BT PHY link setting, wherein the one or more BT parameters are based on the BT PHY link setting.

Example 6 includes the subject matter of Example 5, and optionally, wherein the BT PHY link setting comprises a BT link quality setting.

Example 7 includes the subject matter of Example 5 or 6, and optionally, wherein the BT PHY link setting comprises a BT data rate setting.

Example 8 includes the subject matter of any one of Examples 1-7, and optionally, wherein the communication information comprises information of one or more parameters affecting BT communications by the BT radio.

Example 9 includes the subject matter of any one of Examples 1-8, and optionally, wherein the communication information comprises BT information corresponding to BT transmissions communicated by the BT radio.

Example 10 includes the subject matter of Example 9, and optionally, wherein the BT information comprises BT profile information corresponding to a BT Transmit (Tx) and Receive (Rx) profile of the BT transmissions.

Example 11 includes the subject matter of Example 9 or 10, and optionally, wherein the BT information comprises BT performance information corresponding to the BT transmissions.

Example 12 includes the subject matter of Example 11, and optionally, wherein the BT performance information comprises a BT Packet Error Rate (PER) corresponding to the BT transmissions.

Example 13 includes the subject matter of Example 12, and optionally, wherein the BT PER comprises at least one of a distance-based PER or an environment-based PER.

Example 14 includes the subject matter of any one of Examples 11-13, and optionally, wherein the BT performance information comprises a BT No Acknowledgement (NACK) rate corresponding to the BT transmissions.

Example 15 includes the subject matter of any one of Examples 11-14, and optionally, wherein the BT performance information comprises a BT no synchronization (no-sync) profile of BT no-sync messages.

Example 16 includes the subject matter of any one of Examples 9-15, and optionally, wherein the BT information comprises BT coder/decoder (codec) information corresponding to a BT codec for the BT transmissions.

Example 17 includes the subject matter of any one of Examples 9-16, and optionally, wherein the BT information comprises BT Transmit (Tx) power information corresponding to a Tx power for the BT transmissions.

Example 18 includes the subject matter of any one of Examples 9-17, and optionally, wherein the BT information comprises BT traffic-based information based on a type of BT traffic communicated by the BT radio.

Example 19 includes the subject matter of any one of Examples 1-18, and optionally, wherein the communication information comprises Wireless Local Area Network (WLAN) information corresponding to WLAN transmissions communicated by a WLAN radio of the wireless communication device.

Example 20 includes the subject matter of Example 19, and optionally, wherein the WLAN information comprises WLAN profile information corresponding to a WLAN Transmit (Tx) profile of the WLAN transmissions.

Example 21 includes the subject matter of Example 19 or 20, and optionally, wherein the WLAN information comprises WLAN performance information corresponding to the WLAN transmissions.

Example 22 includes the subject matter of any one of Examples 19-21, and optionally, wherein the WLAN information comprises WLAN Transmission (Tx) window information corresponding to one or more WLAN Tx windows for the WLAN transmissions.

Example 23 includes the subject matter of any one of Examples 19-22, and optionally, wherein the WLAN information comprises Access Point (AP) information corresponding to a WLAN AP to handle the WLAN transmissions.

Example 24 includes the subject matter of any one of Examples 1-23, and optionally, wherein the apparatus is configured to cause the wireless communication device to send device characteristic information to the BT parameter-setting server, the device characteristic information corresponding to one or more characteristics of the wireless communication device, wherein the BT parameter-setting information is based on the device characteristic information.

Example 25 includes the subject matter of Example 24, and optionally, wherein the device characteristic information comprises at least one of device type information to identify a type of the wireless communication device, or manufacturer information to identify a manufacturer of the wireless communication device.

Example 26 includes the subject matter of any one of Examples 1-25, and optionally, wherein the apparatus is configured to cause the wireless communication device to send first communication information to the BT parameter-setting server; process first BT parameter-setting information received from the BT parameter-setting server based on the first communication information to identify a first setting of the one or more BT parameters; configure a first setting of the BT radio according to the first setting of the one or more BT parameters; send second communication information, different from the first communication information, to the BT parameter-setting server; process second BT parameter-setting information received from the BT parameter-setting server based on the second communication information to identify a second setting of the one or more BT parameters, different from the first setting of the one or more BT parameters; and configure a second setting of the BT radio according to the second setting of the one or more BT parameters.

Example 27 includes the subject matter of any one of Examples 1-26, and optionally, wherein the apparatus is configured to cause the wireless communication device to send a message comprising the wireless communication information to the BT parameter-setting server, and to receive the BT parameter-setting information from the BT parameter-setting server based on the message.

Example 28 includes the subject matter of any one of Examples 1-27, and optionally, comprising the BT radio.

Example 29 includes the subject matter of Example 28, and optionally, comprising one or more antennas connected to the BT radio, and a processor to execute instructions of an operating system.

Example 30 includes an apparatus comprising logic and circuitry configured to cause a Bluetooth (BT) parameter-setting server to determine BT parameter-setting information for a wireless communication device based on communication information from the wireless communication device, the communication information based on wireless communications communicated by the wireless communication device, the BT parameter-setting information for the wireless communication device to configure a setting of one or more BT parameters to be implemented by a BT radio of the wireless communication device; and send the BT parameter-setting information to the wireless communication device.

Example 31 includes the subject matter of Example 30, and optionally, wherein the apparatus is configured to cause the BT parameter-setting server to determine the BT parameter-setting information for the wireless communication device based on other BT parameter-setting information from one or more other wireless communication devices, the other BT parameter-setting information based on wireless communications communicated by the one or more other wireless communication devices.

Example 32 includes the subject matter of Example 30 or 31, and optionally, wherein the apparatus is configured to cause the BT parameter-setting server to send first BT parameter-setting information to a first wireless communication device based on first communication information from the first wireless communication device, the first BT parameter-setting information to configure a first setting of one or more first BT parameters to be implemented by a BT radio of the first wireless communication device; and send second BT parameter-setting information to a second wireless communication device based on second communication information from the second wireless communication device, the second BT parameter-setting information to configure a second setting, different from the first setting, of one or more second BT parameters to be implemented by a BT radio of the second wireless communication device.

Example 33 includes the subject matter of any one of Examples 30-32, and optionally, wherein the apparatus is configured to cause the BT parameter-setting server to generate the BT parameter-setting information for the wireless communication device based on a Machine-Learning (ML) output of an ML algorithm trained to generate the ML output based on a ML input, the ML input based on the communication information from the wireless communication device.

Example 34 includes the subject matter of any one of Examples 30-33, and optionally, wherein the BT parameter-setting information comprises BT and Wireless Local Area Network (WLAN) (BT/WLAN) coexistence information to configure a BT/WLAN coexistence scheme, wherein the one or more BT parameters are based on the BT/WLAN coexistence scheme.

Example 35 includes the subject matter of Example 34, and optionally, wherein the BT/WLAN coexistence scheme comprises a BT/WLAN time-sharing scheme, the one or more BT parameters comprising one or more BT timing parameters to configure a timing of BT transmissions to be communicated by the BT radio according to the BT/WLAN time-sharing scheme.

Example 36 includes the subject matter of Example 35, and optionally, wherein the one or more BT timing parameters comprises a BT time window parameter.

Example 37 includes the subject matter of any one of Examples 30-36, and optionally, wherein the BT parameter-setting information comprises BT Physical layer (PHY) link information to configure a BT PHY link setting, wherein the one or more BT parameters are based on the BT PHY link setting.

Example 38 includes the subject matter of Example 37, and optionally, wherein the BT PHY link setting comprises a BT link quality setting.

Example 39 includes the subject matter of Example 37 or 38, and optionally, wherein the BT PHY link setting comprises a BT data rate setting.

Example 40 includes the subject matter of any one of Examples 30-39, and optionally, wherein the communication information comprises information of one or more parameters affecting BT communications by the BT radio.

Example 41 includes the subject matter of any one of Examples 30-40, and optionally, wherein the communication information comprises BT information corresponding to BT transmissions communicated by the BT radio.

Example 42 includes the subject matter of Example 41, and optionally, wherein the BT information comprises BT profile information corresponding to a BT Transmit (Tx) and Receive (Rx) profile of the BT transmissions.

Example 43 includes the subject matter of Example 41 or 42, and optionally, wherein the BT information comprises BT performance information corresponding to the BT transmissions.

Example 44 includes the subject matter of Example 43, and optionally, wherein the BT performance information comprises a BT Packet Error Rate (PER) corresponding to the BT transmissions.

Example 45 includes the subject matter of Example 44, and optionally, wherein the BT PER comprises at least one of a distance-based PER or an environment-based PER.

Example 46 includes the subject matter of any one of Examples 43-45, and optionally, wherein the BT performance information comprises a BT No Acknowledgement (NACK) rate corresponding to the BT transmissions.

Example 47 includes the subject matter of any one of Examples 43-46, and optionally, wherein the BT performance information comprises a BT no synchronization (no-sync) profile of BT no-sync messages.

Example 48 includes the subject matter of any one of Examples 41-47, and optionally, wherein the BT information comprises BT coder/decoder (codec) information corresponding to a BT codec for the BT transmissions.

Example 49 includes the subject matter of any one of Examples 41-48, and optionally, wherein the BT information comprises BT Transmit (Tx) power information corresponding to a Tx power for the BT transmissions.

Example 50 includes the subject matter of any one of Examples 41-49, and optionally, wherein the BT information comprises BT traffic-based information based on a type of BT traffic communicated by the BT radio.

Example 51 includes the subject matter of any one of Examples 30-50, and optionally, wherein the communication information comprises Wireless Local Area Network (WLAN) information corresponding to WLAN transmissions communicated by a WLAN radio of the wireless communication device.

Example 52 includes the subject matter of Example 51, and optionally, wherein the WLAN information comprises WLAN profile information corresponding to a WLAN Transmit (Tx) profile of the WLAN transmissions.

Example 53 includes the subject matter of Example 51 or 52, and optionally, wherein the WLAN information comprises WLAN performance information corresponding to the WLAN transmissions.

Example 54 includes the subject matter of any one of Examples 51-53, and optionally, wherein the WLAN information comprises WLAN Transmission (Tx) window information corresponding to one or more WLAN Tx windows for the WLAN transmissions.

Example 55 includes the subject matter of any one of Examples 51-54, and optionally, wherein the WLAN information comprises Access Point (AP) information corresponding to a WLAN AP to handle the WLAN transmissions.

Example 56 includes the subject matter of any one of Examples 30-55, and optionally, wherein the apparatus is configured to cause the BT parameter-setting server to determine the BT parameter-setting information based on device characteristic information from the wireless communication device, the device characteristic information corresponding to one or more characteristics of the wireless communication device.

Example 57 includes the subject matter of Example 56, and optionally, wherein the device characteristic information comprises at least one of device type information to identify a type of the wireless communication device, or manufacturer information to identify a manufacturer of the wireless communication device.

Example 58 includes the subject matter of any one of Examples 30-57, and optionally, comprising a communication interface to send the BT parameter-setting information to the wireless communication device.

Example 59 includes a server comprising the apparatus of any of Examples 30-58.

Example 60 includes a wireless communication device comprising the apparatus of any of Examples 1-29.

Example 61 includes a mobile device comprising the apparatus of any of Examples 1-29.

Example 62 includes a system comprising the apparatus of any of Examples 1-58.

Example 63 includes an apparatus comprising means for executing any of the described operations of any of Examples 1-58.

Example 64 includes a product comprising one or more tangible computer-readable non-transitory storage media comprising instructions operable to, when executed by at least one processor, enable the at least one processor to cause any of the described operations of any of Examples 1-58.

Example 65 includes an apparatus comprising: a memory interface; and processing circuitry configured to: perform any of the described operations of any of Examples 1-58.

Example 66 includes a method comprising any of the described operations of any of Examples 1-58.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a processor configured to cause a wireless communication device to:
send communication information to a Bluetooth (BT) parameter-setting server, the communication information based on wireless communications communicated by the wireless communication device;
process BT parameter-setting information from the BT parameter-setting server to identify a setting of one or more BT parameters to be implemented by a BT radio of the wireless communication device; and
configure a setting of the BT radio according to the setting of the one or more BT parameters; and
a memory to store information processed by the processor.

2. The apparatus of claim 1, wherein the BT parameter-setting information comprises BT and Wireless Local Area Network (WLAN) (BT/WLAN) coexistence information to configure a BT/WLAN coexistence scheme, wherein the one or more BT parameters are based on the BT/WLAN coexistence scheme.

3. The apparatus of claim 2, wherein the BT/WLAN coexistence scheme comprises a BT/WLAN time-sharing scheme, the one or more BT parameters comprising one or more BT timing parameters to configure a timing of BT transmissions to be communicated by the BT radio according to the BT/WLAN time-sharing scheme.

4. The apparatus of claim 3, wherein the one or more BT timing parameters comprises a BT time window parameter.

5. The apparatus of claim 1, wherein the BT parameter-setting information comprises BT Physical layer (PHY) link information to configure a BT PHY link setting, wherein the one or more BT parameters are based on the BT PHY link setting.

6. The apparatus of claim 1, wherein the communication information comprises information of one or more parameters affecting BT communications by the BT radio.

7. The apparatus of claim 1, wherein the communication information comprises BT information corresponding to BT transmissions communicated by the BT radio.

8. The apparatus of claim 7, wherein the BT information comprises BT profile information corresponding to a BT Transmit (Tx) and Receive (Rx) profile of the BT transmissions.

9. The apparatus of claim 7, wherein the BT information comprises BT performance information corresponding to the BT transmissions.

10. The apparatus of claim 9, wherein the BT performance information comprises a BT Packet Error Rate (PER) corresponding to the BT transmissions.

11. The apparatus of claim 9, wherein the BT performance information comprises a BT No Acknowledgement (NACK) rate corresponding to the BT transmissions.

12. The apparatus of claim 9, wherein the BT performance information comprises a BT no synchronization (no-sync) profile of BT no-sync messages.

13. The apparatus of claim 1, wherein the communication information comprises Wireless Local Area Network (WLAN) information corresponding to WLAN transmissions communicated by a WLAN radio of the wireless communication device.

14. The apparatus of claim 1, wherein the processor is configured to cause the wireless communication device to send device characteristic information to the BT parameter-setting server, the device characteristic information corresponding to one or more characteristics of the wireless communication device, wherein the BT parameter-setting information is based on the device characteristic information.

15. The apparatus of claim 1 comprising the BT radio, one or more antennas connected to the BT radio, and another processor to execute instructions of an operating system.

16. A product comprising one or more tangible computer-readable non-transitory storage media comprising instructions operable to, when executed by at least one processor, enable the at least one processor to cause a wireless communication device to:
send communication information to a Bluetooth (BT) parameter-setting server, the communication information based on wireless communications communicated by the wireless communication device;
process BT parameter-setting information from the BT parameter-setting server to identify a setting of one or more BT parameters to be implemented by a BT radio of the wireless communication device; and
configure a setting of the BT radio according to the setting of the one or more BT parameters.

17. The product of claim 16, wherein the BT parameter-setting information comprises BT and Wireless Local Area Network (WLAN) (BT/WLAN) coexistence information to configure a BT/WLAN coexistence scheme, wherein the one or more BT parameters are based on the BT/WLAN coexistence scheme.

18. The product of claim 16, wherein the instructions, when executed, cause the wireless communication device to send device characteristic information to the BT parameter-setting server, the device characteristic information corresponding to one or more characteristics of the wireless communication device, wherein the BT parameter-setting information is based on the device characteristic information.

19. A method comprising:
sending communication information from a wireless communication device to a Bluetooth (BT) parameter-setting server, the communication information based on wireless communications communicated by the wireless communication device;
processing BT parameter-setting information from the BT parameter-setting server to identify a setting of one or more BT parameters to be implemented by a BT radio of the wireless communication device; and
configuring a setting of the BT radio according to the setting of the one or more BT parameters.

20. The method of claim 19, wherein the communication information comprises Wireless Local Area Network (WLAN) information corresponding to WLAN transmissions communicated by a WLAN radio of the wireless communication device.
